(19) United States
(12) Patent Application Publication
(10) Pub. No.: US 2007/0041388 A1
(43) Pub. Date: Feb. 22, 2007

(54) Device having an embedded Ethernet networking automated link for facilitating configuration of the device and connection of the device to a network

(76) Inventor: Thomas C. Russell, Murray Hill, NJ (US)

Correspondence Address: THE BOC GROUP, INC., 575 MOUNTAIN AVENUE, MURRAY HILL, NJ, 07974-2064, US

(21) Appl. No.: 11/205,564

(22) Filed: Aug. 17, 2005

(51) Int. Cl. H04L 12/28; H04J 3/16

(52) U.S. Cl. 370/400; 370/465

(57) ABSTRACT

The systems and methods of the present invention provide Ethernet devices having various embodiments for embedding in a network device. The Ethernet device is used to configure and operate the network device in a networked environment. The Ethernet device, depending on the embodiment includes at least one of the following items: 1) DHCP server, 2) DHCP client, 3) DNS server, and 4) detection of upstream or downstream connection. The DHCP and DNS servers are used to connect the network device to an external device for use in configuring the network device. Further, the DHCP server and DHCP client may be used to assign an IP address to the network device, when the device is connected in a network.

### BACKGROUND OF THE INVENTION

1. Field of the Invention

The present invention relates generally to systems and methods for connecting network devices to a network, and more specifically to systems and methods that are embedded in a network device and facilitate configuration of the network device in operation of the network device in a network environment.

2. Description of Related Art

The introduction of networking and distributed system architecture has revolutionized manufacturing automation and controls. Specifically, prior to the introduction of local area networks (LAN), most control systems were monitored by direct observation of each control device. This required operators to be physically present on the factory floor to monitor the manufacturing equipment and make adjustments thereto. With the introduction of networks, such as LANs, various control systems could be linked to a remote computing system. This allowed for centralized monitoring of manufacturing equipment at a control center, as opposed to the manufacturing floor. It allowed one or more operators to quickly monitor several different systems at once and make adjustments thereto. Similar advantages were also gained in situations where control systems were located in remote locations, such as different locations within a building, different geographic locations, etc. Instead of requiring an operator to physically visit each location where the controls were located, the operator could receive information from each control at a central location. The introduction of wide area networks (WAN) and the Internet has now made it possible for operators to view data and control equipment from virtually anywhere.

FIG. 1 is a generalized depiction of a distributed system implemented in a networked environment. Specifically, the system 10 includes a plurality of network devices in the form of monitoring and/or controlling devices 12-22 that are distributed about a facility, geographic area, etc. The monitoring and/or controlling devices are connected to a network, such as a LAN, WAN, or the Internet. For example, monitoring and/or controlling devices 12-16 are connected to the Internet via an intermediary control computer 24. This control computer includes an Ethernet connection, not shown, for connecting the control computer to the network 26. Further, the control computer is connected to each of the monitoring and/or controlling devices 12-16 for controlling the devices and receiving data therefrom. Importantly, the control computer includes an IP address, such that it can be contacted via the network.

Monitoring and/or controlling devices 18-22 are somewhat different from monitoring and/or controlling devices 12-16 in that they are directly connected to the network. These devices include an embedded or external Ethernet connection 28 and individual IP addresses, such that each monitoring and/or controlling device can be individually accessed via the network.

As further illustrated, the system includes one or more computing systems 30-34 also connected to the network. In the system, these computing systems allow users located at remote locations to access, receive data from, and control the operation of the monitoring and/or controlling devices 12-22. As such, the system implements a distributed system allowing remote access and control of an automated system.

In order to communicate with devices and computing systems via a network using Transmission Control Protocol/Internet Protocol (TCP/IP), each device must have a unique IP address. This IP address is used to uniquely identify the device on the network. In some cases, the network is limited to a small area, e.g., LAN, while in other networks the area is much larger, e.g., WAN. In either case, the IP address is used by routing and switching equipment on the network to direct Ethernet communications to and from the device.

IP addresses are either static or dynamic. A static address is programmed into the device and does not change. The IP address is selected by a network administrator and is selected such that the IP address does not conflict with the address of any other device on the network. On a large network, this task is difficult, and as such, a dynamic addressing scheme may be used. Typically, a dynamic host control protocol (DHCP) server 36 resides on the network and waits for requests from DHCP clients. DHCP client software is included in the operating software (OS) of each device on the network. In operation, the DHCP client broadcasts a request for a DHCP server to provide an IP address. The DHCP server responds with an available address from a pool of addresses maintained by the server. The address provided by the DHCP server is “leased” to the client and expires after a set period of time. At the end of the lease period, the device must obtain a new lease by making another request to the DHCP server. If the device's lease expires or the device specifically releases the address, the address can be returned to the pool. The DHCP server will also typically provide other configuration information including domain name server (DNS) addresses.

DHCP is a convenient method for automatically assigning IP addresses to computers and other devices in a network environment. A device that does not have any display or human interface can use DHCP to obtain its IP address and other network parameters without any operator intervention. This does present a problem, however, in that the device also has no way to display the IP address that it acquired. Additionally, an operator has no easy way to configure the device to use DHCP or a static IP address. Specifically, as illustrated in FIG. 1, during initial setup or maintenance of a device that does not have a display, access to the device is needed, typically via a PC 38 connected thereto, (shown by dotted line). Without the IP address, a user with a computer connected to the device is not able to access the device to perform configuration and other setup tasks. To deal with this problem, some network devices include special software that runs on a PC and enables the PC to locate the device without using an IP address. The PC can then view the IP address from this utility software and set the network configuration.

As an alternative, a device may be delivered to the end user with a fixed IP address. In this case, a PC 38 is directly connected to the embedded device 18 to perform initial set up or configuration. A hub or a crossover cable is typically used to connect the PC to the device. Since there is no DHCP server in this setup or configuration mode, the network configuration parameters of the PC must be set so as to be compatible with those on the embedded device as shipped from the factory.

Specifically, the most common cable for interconnecting Ethernet devices uses shielded twisted pairs with an RJ45 connector at each end. These pairs are arranged so that each pair carries the signal in one direction between the two connected devices. For this reason, one cannot simply connect one PC to another with a standard cable since each PC would try to transmit on the same wire pair. A hub or switch is thus used to connect the devices. The hub or switch typically contains several ports wired to be “downstream” from the next level up hub or other device. This allows PCs to be connected to the hub with standard cable.

In short, the operation of initializing a device for connection to a network is quite complex and requires use of hubs or switches. It would be advantageous to simplify this operation.

### BRIEF SUMMARY OF THE INVENTION

The present invention provides systems and methods for facilitating configuration and connection of a network device to a network, where the network device includes an embedded Ethernet device. Specifically, the systems and methods of the present invention provides an embedded Ethernet device that includes software and/or hardware for implementing one or more of the following functions: 1) DHCP server, 2) DHCP client, 3) DNS server, and optionally 4) detection of upstream or downstream connection. These various software and/or hardware functions assist in configuration and operation of the network device in the network.

More specifically, in operation, when the network device is first connected to another device via the Ethernet, the Ethernet interface in the network device first determines the role of the network device. The Ethernet device determines whether the network device is connected to the external device in a downstream configuration, e.g., connected to a PC or the like for initial setup, or to the external device in an upstream configuration, e.g., connected to a network. If it is determined that the network device is connected in an upstream configuration, the embedded Ethernet device will first configure the physical connection to operate in an upstream mode. Further, the embedded Ethernet device will also activate the DHCP client software in order to obtain an IP address and other configuration parameters. In an alternative mode, the embedded Ethernet device can use a preloaded static IP address and other. The network device is thus configured by the embedded Ethernet device for communication on the network.

If, on the other hand, the embedded Ethernet device determines that the network device is connected in a downstream configuration, e.g., a PC connected to the device for initial setup, the embedded Ethernet device initially configures the physical connection for downstream communication. Next, the embedded Ethernet device activates its resident DHCP server software and assigns an IP address to the connected downstream device. The embedded Ethernet device may assign itself a static IP address, and the DHCP server will assign an IP address to the downstream device. Typically, the IP address assigned to the downstream device is on the same sub-net for immediate communications.

In addition, in the downstream mode, the embedded Ethernet also activates the DNS software to resolve a host name into an IP address. The DNS software typically used in the embedded Ethernet device is a scaled down version of the DNS software used on large networks and the Internet. Specifically, in the present invention, the DNS software typically needs only to resolve one host name, such as “setup,” into its own IP address. It may even resolve all host names and URLs (uniform record locators) into its own address since it is only device that the PC will need to contact on this temporary simple network. In this way, a user can connect a downstream device, such as a PC, to the embedded Ethernet device, open a web browser on the downstream device, and enter a designated URL, such as http://setup/, without having prior knowledge concerning the factory configuration of the embedded Ethernet device. In this regard, the URL http://setup/ would open a web page with the setup screens for the device and allow the user to configure the device for operation in the intended network.

In the present invention, once the device is configured, the downstream device is disconnected from the embedded Ethernet device. The network device is then connected to a network via the embedded Ethernet device. The embedded Ethernet device would then detect that it is connected to an upstream device and operate in the manner discussed previously to configure the network device for communications with an upstream device.

The present invention may use either an automatic or manual system for detecting and configuring the hardware connection for either upstream or downstream communication. Specifically, the most common cable for interconnecting Ethernet devices uses twisted shielded pairs that are terminated with an RJ45 connector at each end. These twisted shield pairs are arranged so that each pair propagates a signal in one direction. For this reason, two Ethernet devices cannot be just simply connected together by the cable, as both Ethernet devices would attempt to transmit on the said twisted shielded pair. In a manual embodiment, the network device includes a switch or the like for changing the wiring configuration between the network cable and the embedded Ethernet device, such that the electrical connection is properly configured for either upstream or downstream communication depending on the current mode of operation of the network device. If the network device is connected to a PC or the like for configuration, the switch is set for downstream communications, and if the network device is connected to a network, the switch is set for upstream communications.

In an alternative embodiment, the network device may use an automatic upstream/downstream feature. Specifically, conventional hub and switches include ports that were designated for either upstream or downstream communication, whereby the user connected devices together, e.g., PC to network device or network device to network device, by selecting the proper ports for connecting the devices. However, there are now hubs and switches such as the Netgear Model FS105 that use an Auto Uplink™ feature that allows any port to be used for either upstream or downstream communication. This feature detects the wiring configuration of the connected devices to determine the proper mode.

In summary, the systems and methods of the present invention allow for easy configuration of a network device having an embedded Ethernet device, where the IP address of the network device is not readily accessible. Specifically, the systems and methods of the present invention provide an Ethernet device embedded in the network device having one or more of the following functions: 1) DHCP server, 2) DHCP client, 3) DNS, and 4) detection of upstream or downstream connection. In a configuration mode, the embedded Ethernet device detects a downstream connection to a PC or the like and uses its DHCP server software and DNS software to allow the PC to access the configuration settings of the network device using a web browser. After configuration is complete and the network device is connected to an upstream device in a network, the embedded Ethernet device provided by the systems and methods of the present invention either uses its resident DHCP client software to obtain an IP address and other configuration parameters or it may use a preloaded static IP address and other parameters for configuration purposes to thereby connect the network device for communications in the network.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a generalized block diagram of a network containing various devices having embedded Ethernet connections that are accessible remotely by PCs or the like via a network.

FIG. 2 is a block diagram illustrating different hardware/software elements of an embedded Ethernet device according to one embodiment of the present invention.

FIG. 3 is a block diagram illustrating use of an embedded network device according one embodiment of the systems and methods of the present invention to configure a network device for subsequent use in a network.

FIG. 4 is a block diagram illustrating use of an embedded network device according one embodiment of the systems and methods of the present invention to facilitate communication between a network device and other devices via a network.

FIG. 5 is an operation block diagram illustrating an operation mode of an embedded network device according one embodiment of the systems and methods of the present invention to both configure a network device for use in a network and facilitate communications between the network device and other devices via a network.

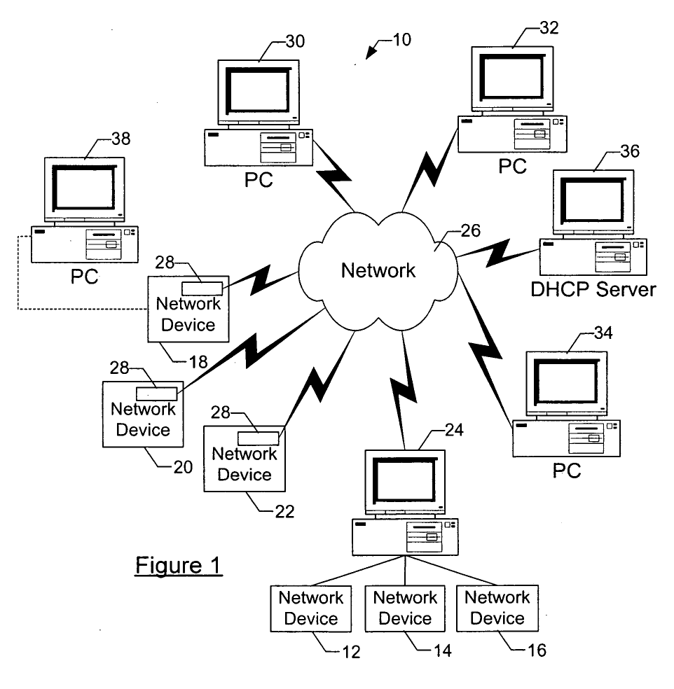

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided as representative examples of the present invention, which includes alternatives within the scope of the average skilled artisan. Like numbers refer to like elements throughout.

As mentioned, the systems and methods of the present invention provide embedded Ethernet devices of various configurations for use in network devices that do not include displays or other mechanisms for readily accessing the IP address of the network device. Specifically, the embedded Ethernet devices provided by the system and methods of the present invention include both a configuration mode and an operation mode. In the configuration mode, the embedded network device facilitates connection of a downstream device, such as a PC or the like, to the network device for configuration of the network device. In an operation mode, the embedded Ethernet device facilitates communication between the network device and other devices via a network in an upstream mode.

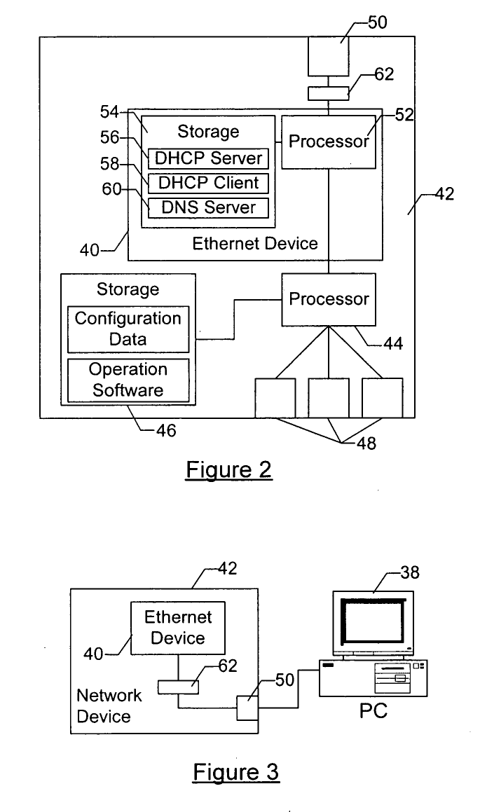

In this regard, FIG. 2 is a generalized view of an embedded Ethernet device 40 located on a network device 42 according to one embodiment of the present invention. In this embodiment, the network device 42 does not include a display or similar mechanism for readily determining the IP address and other configuration information associated with the network device. In this regard, the embedded network device 42 includes software and/or hardware for use in configuring the network device.

The network device may be any type of device that is accessible via a network connection. For example, the network device may be a sensor or controller, a specialized PC or processor, etc. The network device 42 generally includes a processor 44 in the form of a microprocessor or ASIC for performing operations designated by the device. The network device may include a storage device 46, such as memory, for storing instruction code and data. Further, the network device may include sensors, actuators, etc. 48 for performing operations, collecting data, etc. Further, the network device includes a network connection 50 for connecting the network device to a network, such as a local area network (LAN), wide area network (WAN), Internet, etc.

The embedded network device 40 according to one embodiment of the present invention is connected between the processor 44 of the network device 42 and the network connection 50. The embedded network device of the present invention includes many of the same components found on a typical Ethernet connection device. For example, the embedded Ethernet device may include a dedicated processor 52 in the form of a microprocessor or ASIC and a storage device 54. It is noted here that the embedded Ethernet device may instead use the processor 44 and storage device 46 of the network device 42. The embedded Ethernet device controls communications between the network device and other devices connected either directly or indirectly to the network connection 50.

The embedded Ethernet device 40 according to one embodiment of the present invention includes one or more of the following items: 1) DHCP server 56, 2) DHCP client 58, 3) DNS 60, and 4) switch 62 for upstream or downstream communications. These various items may be implemented in software, hardware, or a combination of the two. These items are used by the embedded Ethernet device 40 to facilitate configuration and use of the network device in a network environment.

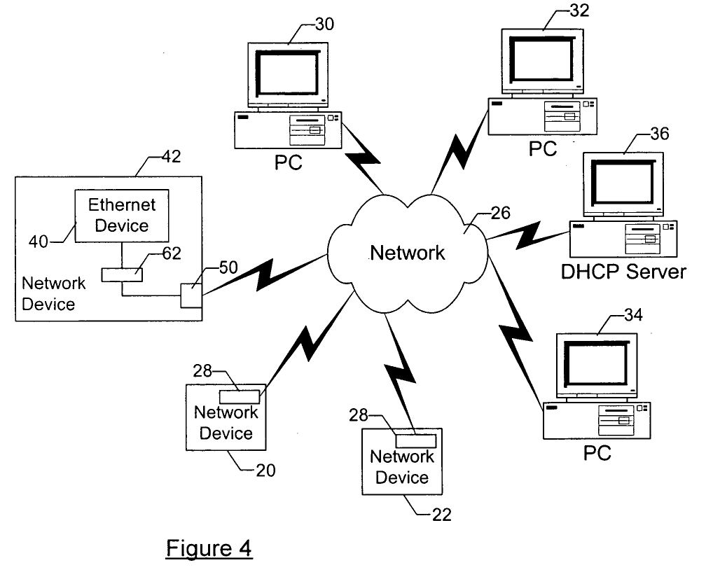

For example, FIG. 3 illustrates an embodiment in which the network device is initially configured for operation. In this embodiment, the network device 42 is connected via a direct link to a PC or the like. The PC is used to set the initial configurations of the network device. As discussed later below, the embedded Ethernet device 40 provided by the systems and methods of the present invention allow network device to be configured without prior knowledge of the network device's IP address and other information. The systems and methods allow the PC to access and alter the configurations of the network device via a web browser.

FIG. 4 illustrates an embodiment in which the network device has been configured and is now operating in a networked environment. As is described below, the embedded Ethernet device 40 provided by the systems and methods of the present invention facilitate connection of the network device for communication with an upstream device and assignment of an IP address to the network device, such that the network device is accessible across the network.

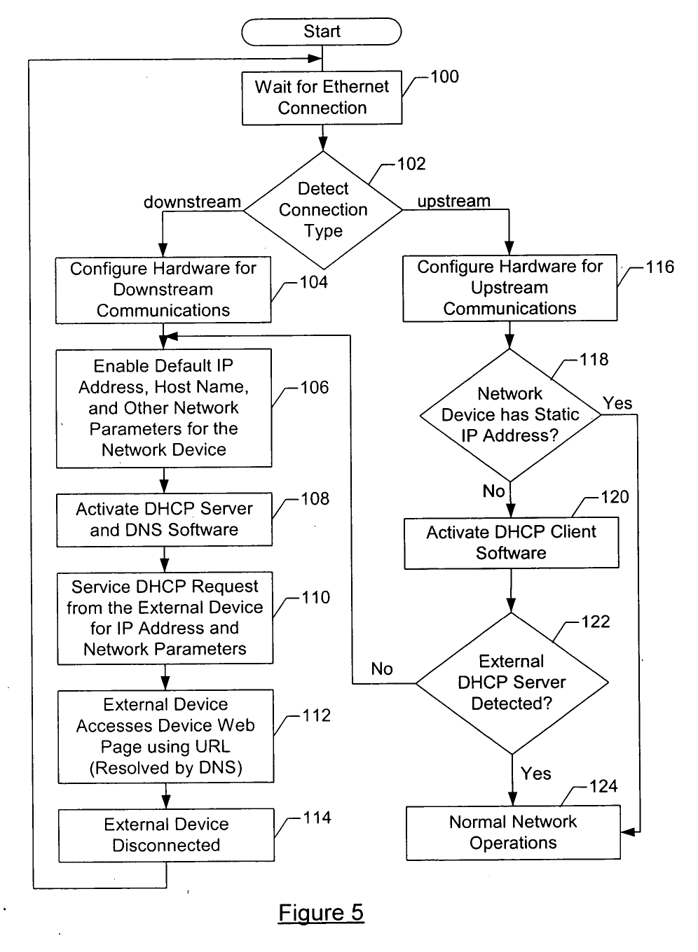

FIG. 5 is a generalized embodiment illustrating at least two modes of operation of an embedded Ethernet device according to one embodiment of the present invention. Specifically, when the network device 42 is initially activated, the network device initially waits for an Ethernet connection. See Block 100. Next a determination is made as to whether the network device is connected in an upstream or downstream communication configuration. See Block 102. This configuration can be determined either by use of a user controlled switching system, manual or otherwise, by which the user indicates the communication configuration. Alternatively, an automatic upstream/downstream detection system, such as known in the art, may be used to detect the communication configuration.

With reference to FIG. 5, operational Blocks 104-114 represent operations performed during downstream communications, such as when the network device is initially configured by a PC or the like. See FIG. 3. In this mode, either user controlled switch or auto-link system is used to configure the hardware for downstream communication. See Block 104. Next, the embedded Ethernet device 40 of the present invention uses a stored static IP address to designate itself in the network with the PC 36. See Block 106. Further, the embedded Ethernet device activates its resident DHCP server and assigns IP address for the connected PC. Typically, the IP address assigned to the PC would be on the same sub-net to permit immediate communications. See Block 108. Note that the DHCP server can also be a simplified version of the software normally run on a server since it only needs to supply a single network address to a single client, thus eliminating the need for address tables and leases.

In addition, in the downstream mode, the embedded Ethernet also activates the DNS software to resolve a host name into an IP address. The DNS software typically used in the embedded Ethernet device is a scaled down version of the DNS software used on large networks and the Internet. Specifically, in the present invention, the DNS software typically needs only to resolve one host name, such as “setup,” into its own IP address. It may even resolve all host names and URLs (uniform record locators) into its own address since it is only device that the PC will need to contact on this temporary simple network. In this way, a user can connect a downstream device, such as a PC, to the embedded Ethernet device, open a web browser on the downstream device, and enter a designated URL, such as http://setup/, without having prior knowledge concerning the factory configuration of the embedded Ethernet device. In this regard, the URL http://setup/ would open a web page with the setup screens for the device and allow the user to configure the device for operation in the intended network.

The DHCP server next services requests from the PC for IP address and network parameters. See Block 110. The user of the PC then invokes a web browser and enters the URL, e.g., http://setup/. See Block 112. The URL opens a web page with the set up screens for the network device and allows the user to configure the network device for operation. This allows the user to gain access to the configuration information associated with the network device, without knowing anything about the network devices configuration before hand. After configuration is complete, the PC is disconnected from the network device. See Block 114.

After the network device has been configured, it is subsequently connected to a network such as is shown in FIG. 4. In this instance, the network device again initially waits for an Ethernet connection. See Block 100. Next a determination is made as to whether the network device is connected in an upstream or downstream communication configuration. See Block 102. When connected to a network, the embedded Ethernet device will determine that it is connected to an upstream device and configure the hardware appropriately. See Block 116. The DHCP client software will next determine an IP address for the network device. First, the DHCP client software will determine whether a static IP address exists. See Block 118. If so, this address is used for normal network operation. See Block 120. Alternatively, the embedded Ethernet device may assign a dynamic IP address to the network device as dictated by a remote DHCP server. See Block 122.

In some instances, it may be that the network device is configured for dynamic addressing using DHCP, but the network device cannot locate a remote DHCP server. See Block 124. In this instance, the embedded Ethernet device can activate its own DHCP server software 56 and assign an IP address to a connected PC. See Blocks 106-114. This would occur in the situation where a PC is connected to the network device for configuration and a hub or switch is used to make the connection. In that case, the network device would configure itself for upstream communications, but would need to respond to the connected PC as if it were connected for downstream communications. The connected PC would typically not be running a DHCP server, so the decision at block 122 would result in a transfer to block 106. Note that it is not necessary for the network device to be disconnected from the PC and then re-connected to a network. It is possible that the operating configuration consists of just the single PC and the network device. In this case, once the network parameters have configured, normal operations could begin immediately.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for facilitating communication in a network comprising:
a network device comprising configuration information used to operate the network device in a network environment;
a connector located on said network device for external communication with said network device;
a storage device located on said network device comprising in a computer readable medium:
instructions for implementing a dynamic host control protocol (DHCP) server;
instructions for implementing a dynamic host control protocol (DHCP) client; and
instructions for implementing a domain name server (DNS); and
an Ethernet device located on said network device, said Ethernet device is in electrical communication with said storage device and said connector, wherein said Ethernet device uses at least one said DHCP server, DHCP client, and DNS instructions for configuring and operating said network device.

2. A system according to claim 1 wherein said Ethernet device determines whether the network device is connected to an external device in an upstream or downstream communication configuration.

3. A system according to claim 2, wherein said Ethernet device is connected to a switch controlled by a user for manually indicating whether the network device is connected in an upstream or downstream configuration.

4. A system according to claim 2, wherein said Ethernet device monitors signals from the connector to determine whether the network device is connected in an upstream or downstream configuration.

5. A system according to claim 1, wherein said network device is connected to an external device in a downstream communication configuration, said Ethernet device assigns a static IP address to the network device, such that said network device is addressable by the external device.

6. A system according to claim 1, wherein said network device is connected to an external device in a downstream communication configuration, said Ethernet device uses said DHCP server to assign an IP address to the external device such that the external device is a addressable by said network device.

7. A system according to claim 1, wherein said network device is connected to an external device in a downstream communication configuration, said Ethernet device uses said DNS server to resolve a host name to be used by the external device when communicating with said network device.

8. A system according to claim 1, wherein said network device is connected to an external device in a downstream communication configuration, said Ethernet device provides configuration information concerning said network device to the external device in the form of web pages.

9. A system according to claim 1, wherein said network device is connected to an external device in a downstream communication configuration, said Ethernet device assigns a dynamic IP address to the network device, such that said network device is addressable by the external device.

10. A system according to claim 9, wherein said Ethernet device assigns a dynamic IP address to said network device as dictated by an external DHCP server.

11. A system according to claim 9, wherein said Ethernet device uses said DHCP server stored in said storage device to assign a dynamic IP address to an external device.

12. A network device for use in a network environment comprising:
a first storage device comprising configuration information used to operate the network device in a network environment;
a connector located on said network device for external communication with said network device;
a second storage device located on said network device comprising in a computer readable medium:
instructions for implementing a dynamic host control protocol (DHCP) server;
instructions for implementing a dynamic host control protocol (DHCP) client; and
instructions for implementing a domain name server (DNS); and
an Ethernet device located on said network device, said Ethernet device is in electrical communication with said storage devices and said connector, wherein said Ethernet device uses at least one said DHCP server, DHCP client, and DNS instructions for configuring and operating said network device.

13. A network device according to claim 12 wherein said Ethernet device determines whether the network device is connected to an external device in an upstream or downstream communication configuration.

14. A network device according to claim 13, wherein said Ethernet device is connected to a switch controlled by a user for manually indicating whether the network device is connected in an upstream or downstream configuration.

15. A network device according to claim 13, wherein said Ethernet device monitors signals from the connector to determine whether the network device is connected in an upstream or downstream configuration.

16. A network device according to claim 12, wherein said network device is connected to an external device in a downstream communication configuration, said Ethernet device assigns a static IP address to the network device, such that said network device is addressable by the external device.

17. A network device according to claim 12, wherein said network device is connected to an external device in a downstream communication configuration, said Ethernet device uses said DHCP server to assign an IP address to the external device such that the external device is a addressable by said network device.

18. A network device according to claim 12, wherein said network device is connected to an external device in a downstream communication configuration, said Ethernet device uses said DNS server to resolve a host name to be used by the external device when communicating with said network device.

19. A network device according to claim 12, wherein said network device is connected to an external device in a downstream communication configuration, said Ethernet device provides configuration information concerning said network device to the external device in the form of web pages.

20. A network device according to claim 12, wherein said network device is connected to an external device in a downstream communication configuration, said Ethernet device assigns a dynamic IP address to the network device, such that said network device is addressable by the external device.

21. A network device according to claim 20, wherein said Ethernet device assigns a dynamic IP address to said network device as dictated by an external DHCP server.

22. A network device according to claim 20, wherein said Ethernet device uses said DHCP server stored in said second storage device to assign a dynamic IP address to an external device.

23. A network device according to claim 12, wherein said first and second storage devices are the same device.

24. An Ethernet device for facilitating communications between a network device and external devices comprising:
a connector located on the network device for external communication with the network device;
a storage device located on the network device comprising in a computer readable medium:
instructions for implementing a dynamic host control protocol (DHCP) server;
instructions for implementing a dynamic host control protocol (DHCP) client; and
instructions for implementing a domain name server (DNS); and
a processor located on the network device, said processor is in electrical communication with said storage device and said connector, wherein said processor uses at least one said DHCP server, DHCP client, and DNS instructions for configuring and operating the network device.

25. An Ethernet device according to claim 24 wherein said Ethernet device determines whether the network device is connected to an external device in an upstream or downstream communication configuration.

26. An Ethernet device according to claim 24, wherein the network device is connected to an external device in a downstream communication configuration, said processor assigns a static IP address to the network device, such that the network device is addressable by the external device.

27. An Ethernet device according to claim 24, wherein the network device is connected to an external device in a downstream communication configuration, said processor uses said DHCP server to assign an IP address to the external device such that the external device is a addressable by the network device.

28. An Ethernet device according to claim 24, wherein the network device is connected to an external device in a downstream communication configuration, said processor uses said DNS server to resolve a host name to be used by the external device when communicating with the network device.

29. An Ethernet device according to claim 24, wherein the network device is connected to an external device in a downstream communication configuration, said processor provides configuration information concerning the network device to the external device in the form of web pages.

30. An Ethernet device according to claim 24, wherein the network device is connected to an external device in a downstream communication configuration, said processor assigns a dynamic IP address to the network device, such that the network device is addressable by the external device.

31. An Ethernet device according to claim 30, wherein said processor assigns a dynamic IP address to the network device as dictated by an external DHCP server.

32. An Ethernet device according to claim 30, wherein said processor uses said DHCP server stored in said storage device to assign a dynamic IP address to the external device.
